(19) United States
(12) Patent Application Publication
(10) Pub. No.: US 2013/0159271 A1
(43) Pub. Date: Jun. 20, 2013

(54) GRAPHICAL USER INTERFACE FOR WEB BROWSER

(71) Applicant: Eyal Ophir, Palo Alto, CA (US)

(72) Inventor: Eyal Ophir, Palo Alto, CA (US)

(73) Assignee: ROCKMELT, INC., Mountain View, CA (US)

(21) Appl. No.: 13/327,329

(22) Filed: Dec. 15, 2011

(51) Int. Cl. G06F 17/30

(52) U.S. Cl. 707/706; 707/E17.108

(57) ABSTRACT

A graphical user interface (GUI) module receives textual input from a user, determines recommendations based on the received input and the user's navigation network (that includes additional users associated with the user). The GUI interface then determines properties associated with the determined recommendations, and presents the one or more recommendations and graphical representations of their associated properties for display to the user.

### BACKGROUND

1. Field of Disclosure

The disclosure generally relates to browser applications, in particular to providing a graphical user interface that enables efficient web browsing.

2. Description of the Related Art

The internet in the past thirty years has evolved from a collection of online textual documents accessible by a selected group of technocrats to a multimedia enriched environment where people from all different walks of life interact and conduct business. While the online content has evolved to make information more convenient and accessible for the user, the web browser which is the gateway to this dynamic online world is still a work in progress. Most of the users today are still typing a relatively cumbersome uniform resource locator (URL) or sifting through various web pages to access the desired content.

### SUMMARY

Embodiments of the invention presents a user with a graphical user interface including one or more recommendations associated with textual input received from the user, and graphical representations of recommendations' associated properties. In one embodiment, a graphical user interface (GUI) module receives textual input from the user, determines recommendations based on the received input and the user's navigation network (that includes additional users associated with the user). The GUI interface then determines properties associated with the determined recommendations, and presents the one or more recommendations and graphical representations of their associated properties for display to the user. Examples of determined recommendations include the user's online friends, web content, search terms and web applications associated with the received textual input. Examples of properties associated with the determined recommendations include an online friend's ability to receive a message, sources or users who have interacted with the web content, and search services for implementing searches for the search terms.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 illustrates a user interface that provides a user with various graphical options to help the user navigate to a desired online web page or application associated with the user's online friend.

FIG. 2 illustrates three embodiments of an interface that receives textual input from a user and displays content recommendations and their associated properties as suggested actions to the user.

FIG. 3 illustrates two embodiments of an interface including preview windows for recommended content.

FIG. 4 illustrates two embodiments of an interface that receives textual input and displays a search term recommendation and the term's associated properties as suggested actions.

FIG. 5 illustrates three embodiments of an interface that receives textual input and displays a web address as recommendation and the address' associated properties as suggested actions.

FIG. 6 is a block diagram illustrating an example of a computer for use in displaying user interfaces illustrated in FIGS. 1-5, according to one embodiment.

### DESCRIPTION

A graphical user interface (GUI) module in an application, like a browser, presents a user with various graphical options to help the user navigate to a desired online web page or application. A user may type free flowing text into a text bar for the browser like an address bar, a search bar, or an omnibar (i.e., the combined address bar and search bar). Based on the typed text, the GUI module presents a user with an interface with various recommendations based on the typed text. For example, a user may partly type a name of an online friend in the omnibar and the GUI module presents the friend's name as a recommendation. Additionally, the GUI module presents graphical representations of various properties associated with the friend like the friend's ability to receive email or a message on a social network. The user may select one of the graphical representations to contact the friend.

The user therefore need not type the address of the social networking site, access the friend's profile page, select the message option and create a message for the friend. Instead of these numerous steps, the GUI module beneficially provides the user with an interface that includes various suggested actions to contact the friend responsive to a single step of the user typing in the friend's name in the omnibar.

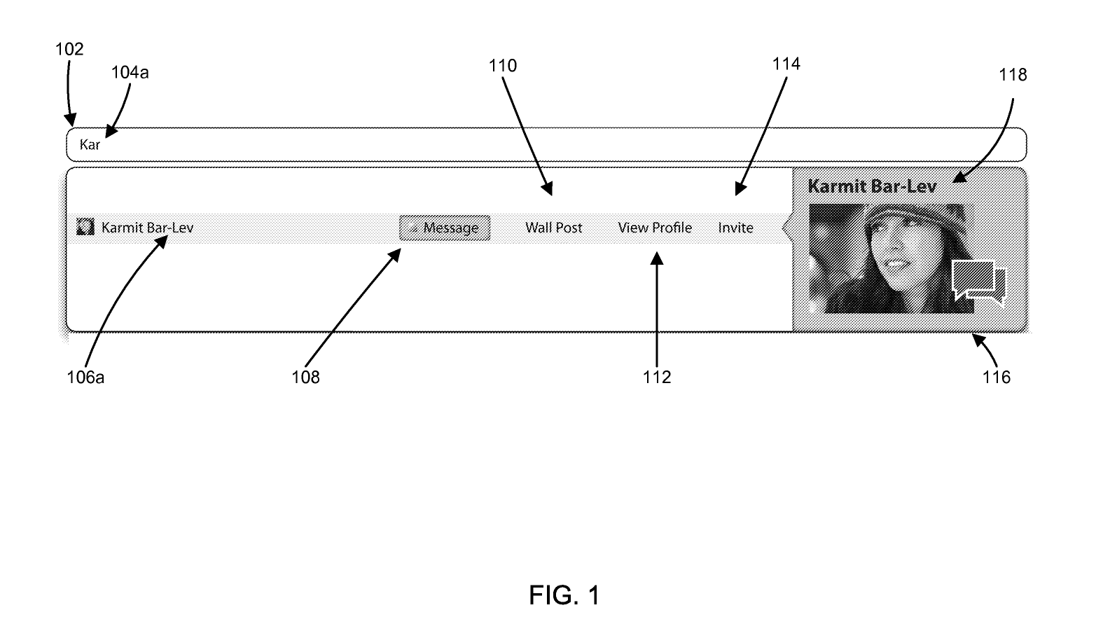

FIG. 1 illustrates an interface that receives textual input from a user and displays the user's friend and the friend's associated properties as suggested actions. The interface includes a text box 102 for receiving textual input from the user. The text box 102 is an address bar, search bar, or an omnibar located on a web browser. Alternatively, the text box 102 is located on a web site or a client application. One of ordinary skill in the art, after reading this disclosure, will understand that the functionality associated with the text box and the GUI module may be incorporated in various applications besides a web browser or a web page.

The text box 102 is configured to receive free flowing text that need not adhere to a particular format like a web address format or an email format. Instead the user may enter free flowing text without worrying about the formatting issues. Alternatively, the text box 102 may require text in a particular format. Regardless of the format requirement, the text box 102 receives the text from the user and transmits the text to a recommendation module (not shown).

The recommendation module determines recommendations based on the received text and optionally on the identity of the user that provides the textual input. The recommendation module transmits the determined recommendations to the GUI module. The system and method for determining recommendations for a user are described in application titled “Social Web Browsing” included in Appendix A below. Examples of recommendations associated with the received text include a user's online friends, web applications and web pages recommended, viewed or interacted upon by the user's friends.

The GUI module receives the determined recommendations and determines properties associated with the recommendations. In one embodiment, the GUI module receives the properties from the recommendation module along with the recommendations. In another embodiment, the GUI module queries the recommendation module or the source of the recommendations for the recommendations' properties. In yet another embodiment, the GUI module is pre-configured with properties for different types of recommendations. After receiving the recommendations and determining their associated properties, the GUI module provides the received information for display as suggested actions to the user. The recommendations and their associated properties are displayed to the user as the user is providing the textual input or within a threshold time of the user providing the textual input. Various recommendations, their properties and example display of these properties are described further below.

Referring again to FIG. 1, it illustrates a text box 102 that has received “Kar” 104a as textual input from the user. Responsive to receiving this input, the recommendation module determines as recommendation one of user's online friends that includes the received “kar” text in their name. In other embodiments, the received text may match other information for the recommended friend like the friend's location, interests, posts etc. As illustrated in FIG. 1, the recommendation module determines a user's friend named “Karmit Bar-Lev” 106 as a recommendation based on the received text 104. The GUI module determines various properties associated with the recommended friend and provides graphical representations 108-118 of these properties for display as suggested actions to the user. The graphical representations 108-118 include a graphical interface button 108 titled “message” that represents the friend's ability to receive instant, online or offline messages. The user may select this button 108 to send a message to the recommended friend. Similarly, the user may select the graphical interface button 110 titled “wall” to post a message to the recommended friend's wall. Additionally, the user may select graphical interface button 112 to view the friend's profile and graphical interface button 114 to invite a friend to use a new application or participate in an online activity. In one embodiment, as illustrated in FIG. 1, the GUI module also provides the friend's name 118 and friend's picture 116 to help the user better identify the recommended friend.

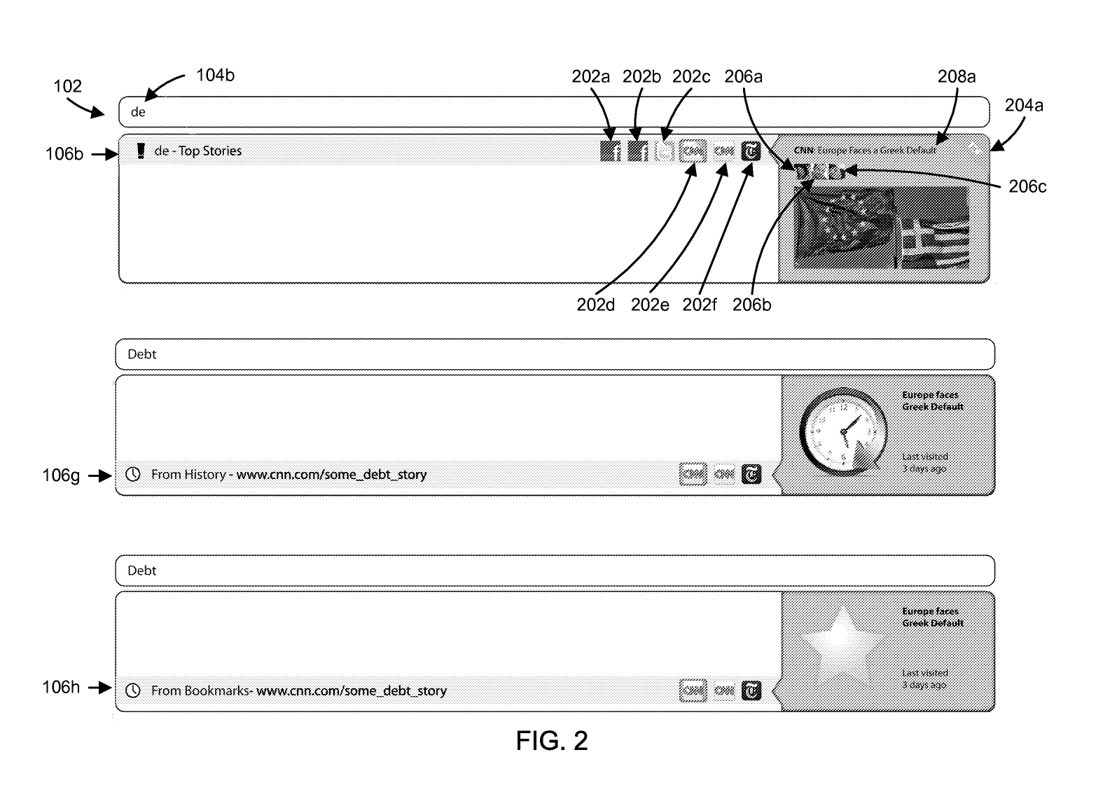

FIG. 2 illustrates three embodiments of an interface that receives textual input from a user and displays content recommendations and their associated properties as suggested actions to the user. In the first embodiment, the user provides “de” 104b as textual input and the GUI module provides for display a collection of one or more top stories related to the textual input 104b as recommended content 106b for display. The top stories include updates, articles, news, or other information about an online entity. Additionally, the top stories have properties like the stories' sources and the online users that have interacted with the stories. Examples of the interacting online users for a story include users who have viewed or recommended the online story. In one embodiment, the interacting online users are also online friends of the user that provided the textual input 104b. Examples of top stories' sources include news websites, social networking websites, messaging services, and other content services that provide a platform for a user to provide or share stories.

In addition to providing top stories as recommended content 106b, the GUI module provides graphical icons 202a-f representing the source of each top story. In one embodiment, the GUI module provides for display the graphical icons representing sources for a threshold number of top stories. The GUI module may provide one top story from each source or multiple stories from a particular source. The graphical icons 202a-f represent a suggested action of accessing a top story from a particular source, and a user may access a top story by selecting one of the graphical icons 202a-f.

In response to selection of one of the graphical icons 202a-f, the GUI module in one embodiment provides for display a preview window 204a. In one embodiment, the preview window is displayed in response to a cursor moving over one of the graphical icons 202a-f and selection of the graphical icon leads to display of a more detailed view for the top story. The preview window 204a displays a preview for the top story associated with the selected graphical icon. For example, as illustrated in FIG. 2, the preview window 204 displays the title 208 of the top story and graphical representations (e.g. images) 206a-c that convey the identity of users who have interacted with the top story.

In the second embodiment of the illustrated interface, responsive to receiving the textual input, the GUI module provides for display a collection of web pages from the user's browsing history as recommendations 106g. Like the first embodiment of the interface, the GUI module also provides graphical representations of the sources of these web pages that may be selected to access the recommended page from a particular source. In the third embodiment of the illustrated interface, the GUI module provides for display a collection of web pages from the user's bookmarks as recommendations 106f. The GUI module also provide for display graphical representations of the sources of the bookmarked pages.

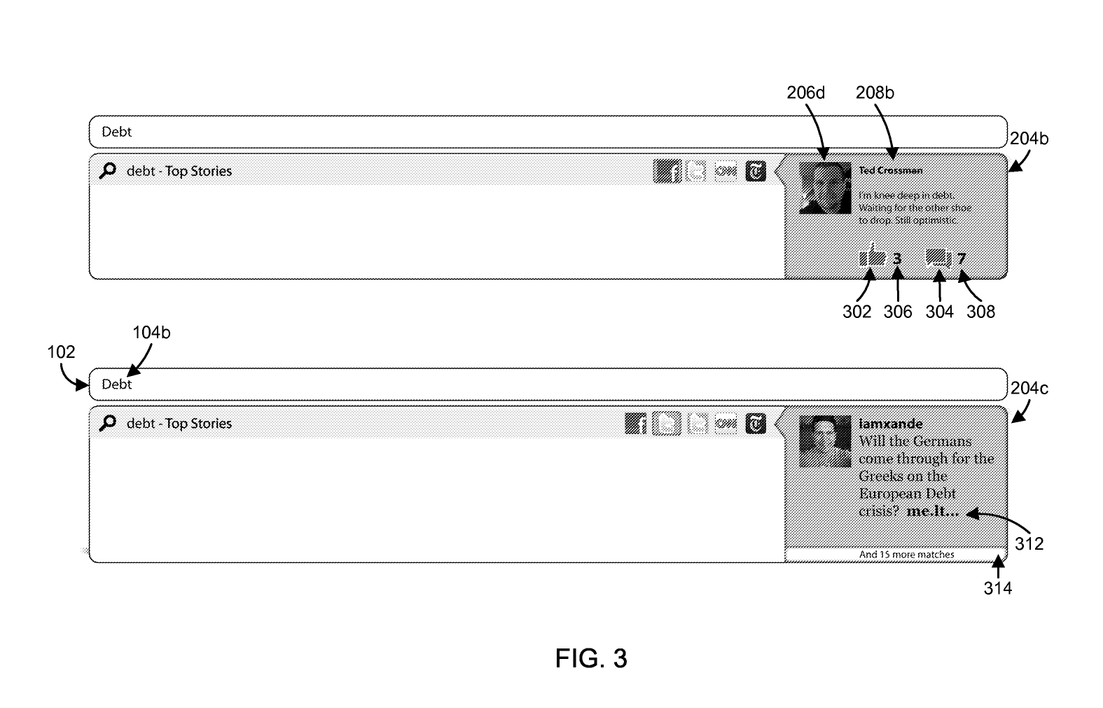

FIG. 3 illustrates two embodiments of an interface including preview windows for recommended content. The first preview window 204b, like the preview window 204a in FIG. 2, includes a title 208b and a graphical representation 206d of an interacting user for the top story previewed in the first preview window 204b. For this previewed top story, the interacting user is the creator of the top story and the title 208b is the name of the interacting user. Additionally, the preview window 204b includes icons 302, 304 representing users who have liked (or recommended) the previewed top story and users who have commented on the top story. The preview window also includes the number 306 of users who have liked the top story and number 308 of users who have commented on the top story. In one embodiment, the icons 302, 304 representing users are also suggested actions for requesting additional information regarding the represented users. For example, in response to selection of icon 302, the preview window 204b may display the identity of the users who liked the content. Similarly, in response to selection of icon 304, the preview window 204b may display the comments and the commenting users associated with the top story. The preview window 204b may itself represent a suggested action and selection of the preview window 204b may open a web page or an application where a user can view, comment on, like, forward or take other actions related to the previewed story. In one embodiment, the opened web page or application is automatically filed with information about the previewed top story and the user need not copy the information in the opened web page or application. For e.g., upon selection of a graphical representation indicating a forwarding action, the opened page may already include the title, link or body of the top story being forwarded. The second preview window 204c, like the first preview window 204b, includes a title for the previewed top story and a graphical representation of the interacting user. Additionally, the second preview window 204c includes a link 312 to the previewed story. Selection of the link opens a web page including the top story. In one embodiment, the second preview window 204c also includes a graphical indicator 314 that informs a user that the source or the interacting user of the previewed top story is associated with additional top stories related to the textual input 104c received in the text box 102. Alternatively, the graphical indicator 314 informs a user that additional stories related to the textual input 104 are available from various sources. In one embodiment, the graphical indicator also informs the user about the number of available stories. Selection of the graphical indicator 314 leads to display of the additional stories.

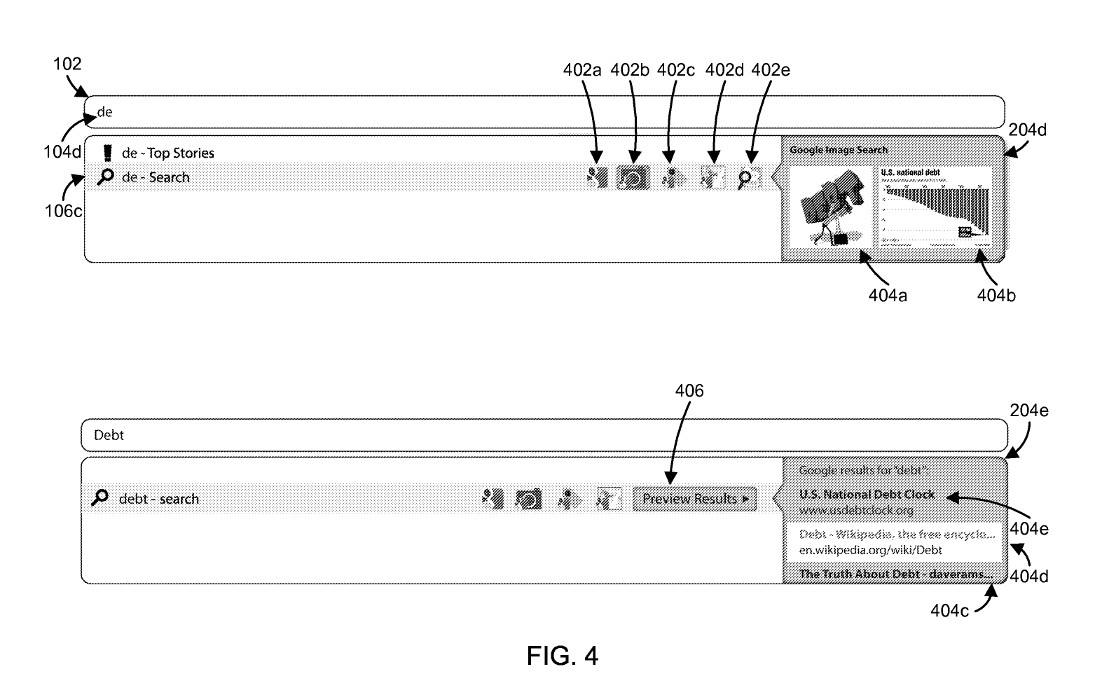

FIG. 4 illustrates two embodiments of an interface that receives textual input and displays a search term recommendation and the term's associated properties as suggested actions. In the first embodiment of the illustrated interface, the text box 102 has received “de” as textual input and the GUI module has provided for display “de” as a recommended search term 106c. In other embodiments, the GUI module may receive from recommendation module and provide for display search terms that are not identical to the textual input (for e.g. recommended term “debt” for textual input “de”). The associated properties for the recommended search term 106c include various search engines or services that may be used to search for results related to the search term. The GUI module provides for display graphical representations 402a-e for these search services as suggested actions to the user. The user may select one of these graphical representations 402a-e to search for the recommended search term on the search service associated with the selected representation. In one embodiment, the selection leads to a page with displayed search results from the selected service. In another embodiment, the GUI module also provides a preview window 204d that is displayed in response to selection of a graphical representation 402a-e (through actions like clicking or moving a cursor over the graphical representation). The graphical window 204d includes preview of the search results 404a-b received from the selected search service.

In the second embodiment of the illustrated interface, the GUI module provides a preview results icon 406 for display along with the graphical representations for various search services. Additionally, the GUI module provides a preview window 204e that is displayed in response to selection of the preview results icon 406. The preview window 204e includes combined search results 404c-e from two or more search services associated with the graphical representations.

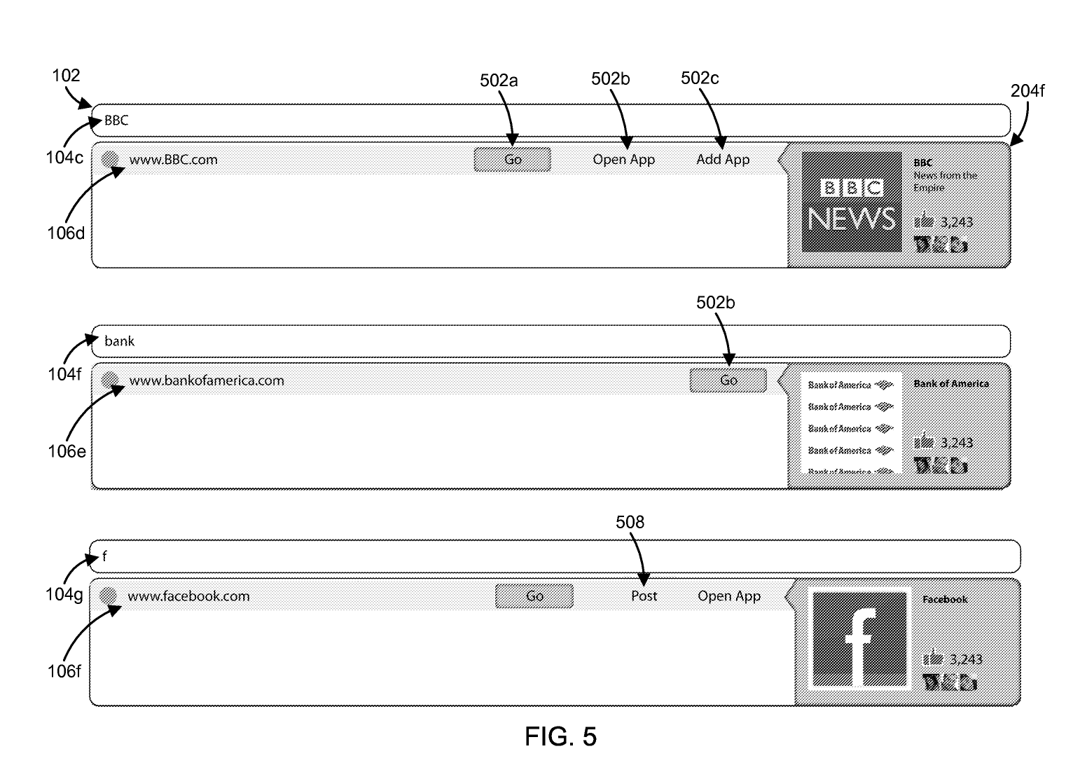

FIG. 5 displays three embodiments of an interface that receives textual input and displays a web address as recommendation and the address' associated properties as suggested actions. In the first embodiment, the text box 102 has received “BBC” as textual input 104e, and responsive to receiving the textual input, the GUI module provides “www.bbc.com” as the recommended web address. In other embodiments, the GUI module may provide a plurality of web addresses as recommendations. The associated properties for the recommended web address include a web page that may be accessed through the web address and an application associated with the web address. The application may be opened or added as a favorite (or its shortcut may be added) by the user for later access. In addition to the recommended web address 106d, the GUI module provides for display a graphical representation 502 that may be selected by the user to access the page associated with the recommended web address. Additionally, the GUI module provides for display a graphical representation 504 for opening the application associated with the web address and graphical representation 506 for adding the application as a favorite. The GUI module also provides a preview window 204f that is displayed in response to selection of graphical representation 502a.

In the second embodiment, the recommended web address 106e does not have an associated application and therefore the GUI module does not provide for display graphical representations 504-506 for opening the application or adding the application as a favorite.

In the third embodiment, the recommended web address 106f has an application and a particular function “post” associated with the recommended address. Accordingly, the GUI module has provided a graphical representation 508 titled “post” associated with the function. The graphical representation 508 beneficially allows a user to access the associated function directly from the displayed interface instead of accessing the web page associated with the recommended web address 106f and selecting the function on the accessed web site.

The description of the figures above conveys different types of recommendations being displayed in different interfaces. One of ordinary skill in the art will understand that recommendations illustrated in different figures may be recommended together. For e.g., the GUI module may provide friends, top stories and web addresses as recommendations in response to receiving a textual input.

### Computer Architecture

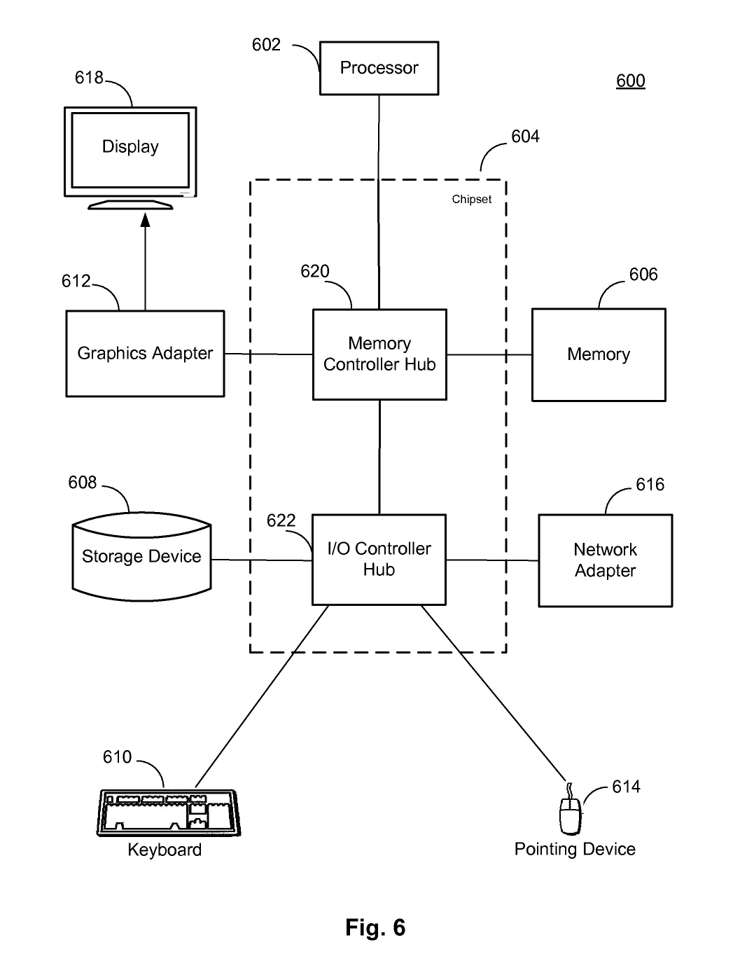

The GUI module is implemented using one or more computers. FIG. 6 is a high-level block diagram illustrating an example computer 600. The computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, or other type of pointing device, and is used in combination with the keyboard 610 to input data into the computer system 600. The graphics adapter 612 displays images and other information on the display 618. The network adapter 616 couples the computer system 600 to one or more computer networks.

The types of computers 600 used to implement the windows module can vary depending upon the embodiment and the processing power required by the entity. For example, the windows module might comprise multiple blade servers working together to provide the functionality described herein. The computers 600 can lack some of the components described above, such as keyboards 610, graphics adapters 612, and displays 618.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the user interface arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method for providing a graphical interface to traverse online content, the method comprising:
receiving textual input from a user, the user having a navigation network including additional users who are associated with the user in one or more external social networking systems;
determining a plurality of recommendations based on the textual input and the navigation network, wherein a first recommendation is associated with web content;
receiving from at least one external social networking system information about one or more of the additional users who have interacted with the web content in the at least one external social networking system;
providing for display the first recommendation and a graphical representation of the one or more additional users, the graphical representation identifying one or more of the additional users who have interacted with the web content in the at least one external social networking system.

2. The computer-implemented method of claim 1, wherein a second recommendation is an online friend of the user, and further comprising providing for display the second recommendation and an interface that enables the user to contact the online friend.

3-4. (canceled)

5. The computer-implemented method of claim 1, further comprising providing for display a graphical representation of a source of the web content.

6. The computer-implemented method of claim 1, further comprising providing for display a preview window associated with the first recommendation, the preview window including a title associated with the first recommendation.

7. (canceled)

8. The computer-implemented method of claim 1, wherein a second recommendation is a search term, and further comprising providing for display a graphical representation of a search service for obtaining search results for the search term.

9. The computer-implemented method of claim 1, further comprising providing for display a graphical representation of a web application associated with the web content.

10. The computer-implemented method of claim 9, wherein selection of the graphical representation of the web application results in the web application being added as a favorite application for the user.

11. A non-transitory computer-readable medium for providing a graphical interface to traverse online content, the computer-readable medium including computer program code for:
receiving textual input from a user, the user having a navigation network including additional users who are associated with the user in one or more external social networking systems;
determining a plurality of recommendations based on the textual input and the navigation network, wherein a first recommendation is associated with web content;
receiving from at least one external social networking system information about one or more of the additional users who have interacted with the web content in the at least one external social networking system;
providing for display the first recommendation and a graphical representation of the one or more additional users, the graphical representation identifying one or more of the additional users who have interacted with the web content in the at least one external social networking system.

12. The non-transitory computer-readable medium of claim 11, wherein a second recommendation is an online friend of the user, and further comprising providing for display the second recommendation and an interface that enables the user to contact the online friend.

13.-14. (canceled)

15. The non-transitory computer-readable medium of claim 11, further comprising computer program code for providing for display a graphical representation of a source of the web content.

16. The non-transitory computer-readable medium of claim 11, further comprising computer program code for providing for display a preview window associated with the first recommendation, the preview window including a title associated with the first recommendation.

17. (canceled)

18. The non-transitory computer-readable medium computer of claim 11, wherein a second recommendation is a search term, and further comprising computer program code for providing for display a graphical representation of a search service for obtaining search results for the search term.

19. The non-transitory computer-readable medium of claim 11, further comprising computer program code for providing for display a graphical representation of a web application associated with the web content.

20. The non-transitory computer-readable medium claim 19, wherein selection of the graphical representation of the web application results in the web application being added as a favorite application for the user.
